(19) United States
(12) Patent Application Publication
(10) Pub. No.: US 2026/0236422 A1
(43) Pub. Date: Aug. 13, 2026

(54) INTER-INTEGRATED CIRCUIT (I2C) DEVICE ASSIGNMENT ADJUSTMENT

(71) Applicant: Aivres Systems Inc., San Jose, CA (US)

(72) Inventors: Mingduo KAO, New Taipei City (TW); Huei ming CHU, New Taipei City (TW)

(21) Appl. No.: 19/050,778

(22) Filed: Feb. 11, 2025

(51) Int. Cl. G06F 13/42

(52) U.S. Cl. CPC G06F 13/42; G06F 2213/0016

(57) ABSTRACT

One or more embodiments of the present specification provide inter-integrated circuit (I2C) device assignment methods, apparatuses, and systems. Status signals, each corresponding to an I2C device of one or more I2C devices, are detected as detected status signals by a microcontroller unit (MCU). An identifier for each I2C device corresponding to each detected status signal is determined. The I2C device corresponding to each detected status signal is assigned to a respective channel corresponding to a baseboard management controller (BMC). A signal indicating an assignment update of at least one of the I2C devices corresponding to the detected status signals to a respective different channel is received. A current assignment is updated in response to receiving the assignment update.

### BACKGROUND

Computing devices, such as servers, are widely used in a variety of fields. In areas such as artificial intelligence (AI) and big data, the need for high-performance computing devices is growing rapidly.

Some computing devices use an inter-integrated circuit (I2C) communication protocol to connect devices such as microcontrollers, processors, sensors, or displays of the computing device. The I2C protocol allows multiple devices to communicate on a shared bus. I2C involves a Serial Data Line (SDL) signal line for data transfer and a Serial Clock Line (SCL) signal line for synchronizing the data transfer. A master device, also referred to as controller device, sends commands and data to slave devices, also referred to as peripheral devices. The peripheral devices transmit data if addressed by the controller device, with each device on the bus having a unique I2C address. In some examples, in a controller-peripheral architecture, one device acts as the controller device, and all the other devices are peripheral devices. In a multi-controller architecture, multiple controller devices share the same bus. In a hybrid architecture, one device or multiple devices can act as controller devices, and multiple devices can be peripheral devices. The layout of a printed circuit board (PCB) of the computing device can affect the reliability and efficiency of the computing device. For example, each component in communication with a controller device should have a unique I2C address. Furthermore, electrical design considerations such as proper power supply, resistance, and capacitance can ensure signal stability and immunity to interference.

### SUMMARY

The present disclosure describes systems and techniques to update the assignment of inter-integrated circuit (I2C) devices.

In an implementation, one or more status signals, each corresponding to an I2C device of one or more I2C devices, are detected by a microcontroller unit (MCU) as detected status signals. An identifier for the I2C device corresponding to each detected status signal of the detected status signals is determined by the MCU. The I2C device corresponding to each detected status signal of the detected status signals is assigned by the MCU to a respective channel corresponding to a baseboard management controller (BMC). A signal indicating an assignment update of at least one of the I2C devices corresponding to the detected status signals to a respective different channel is received by the MCU. A current assignment is updated according to the assignment update as an updated assignment in response to receiving the signal.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. The described systems and techniques can accommodate updating assignment of I2C devices without a need to manually validate, troubleshoot, and manufacture a printed circuit board (PCB) to adjust the assignment of the I2C devices. Manually validating and troubleshooting the layout of a PCB requires developing the layout and manufacturing the PCB according to the layout, which can require a large amount of time and resources, particularly over multiple iterations of validation and troubleshooting. For example, each PCB can include or be connected to a large number, e.g., tens or hundreds, of I2C devices. Developing the computing device also involves determining a configuration of a backplane and buses such as a peripheral component interconnect express (PCIe) bus. The layout of the I2C devices can also impact performance of the computing device. For example, proper electrical design, e.g., power supply, resistance, and capacitance, can ensure signal stability and immunity to interference. Furthermore, the performance of the computing device can be optimized based on a layout and length of signal lines, e.g., to avoid electromagnetic interference and signal distortion. As another example, the clock frequency can be adjusted based on a speed class of the I2C communication protocol to balance speed and stability.

The development of the computing device can also involve a large number of documents, e.g., proposed layouts, I2C device requirements, or simulations, developed by a large number of developers or engineers. The complexities of the computing device and development process may result in I2C address conflicts or uneven performance. In some cases, addressing a mistake during development may require a hardware revision, which is time and resource intensive. Thus, the systems and techniques allow for dynamic adjustment of the I2C assignment, allowing for more efficient development of computing devices. The described systems and techniques can reduce the time and resources required to develop and evaluate layouts.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram of a system for updating the assignment of inter-integrated circuit (I2C) devices using a microcontroller unit (MCU), according to an implementation of the present disclosure.

FIG. 2 is a block diagram of the MCU of FIG. 1, according to an implementation of the present disclosure.

FIG. 3 is a flowchart illustrating an example of a computer-implemented method for updating the assignment of I2C devices using an MCU, according to an implementation of the present disclosure.

FIG. 4 is a flowchart illustrating an example of a computer-implemented method for determining identifiers for I2C devices, according to an implementation of the present disclosure.

FIG. 5 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes systems and techniques to update the assignment of inter-integrated circuit (I2C) devices and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

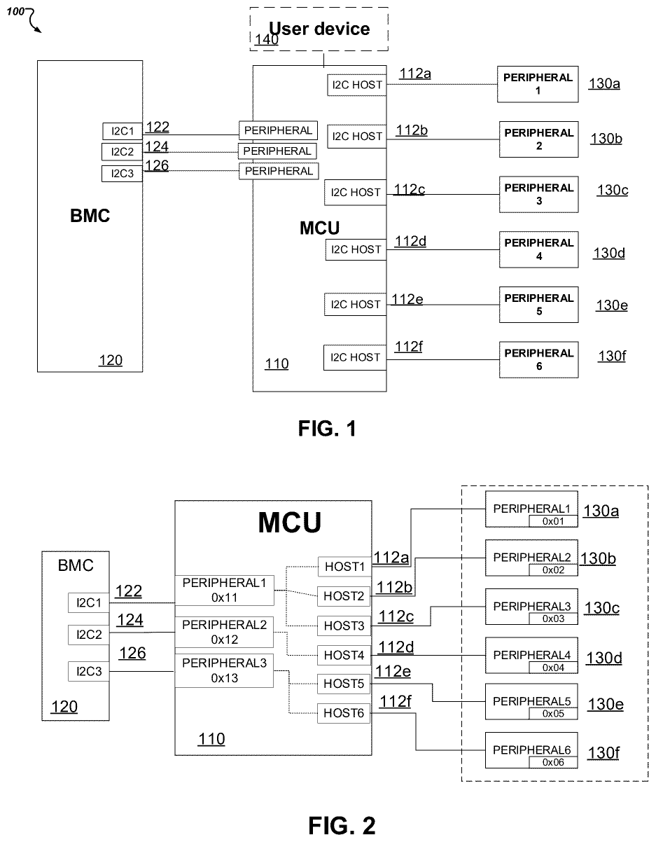

FIG. 1 is a block diagram of a computing device 100 for updating the assignment of I2C devices using a microcontroller unit (MCU) 110, according to an implementation of the present disclosure. The computing device 100 includes an MCU 110 that includes a microcontroller and other components such as a power supply circuit, input and output pins, and communication interfaces.

In some implementations, the MCU 110 can be part of a printed circuit board (PCB) of the computing device 100. As a particular example, the PCB can be the motherboard of the computing device 100. The motherboard is the main circuit board that connects the computing device's internal components and external components, and allows them to communicate with each other. For example, the motherboard can connect one or more processors, memory, graphics card, and other hardware.

The motherboard can include a Baseboard Management Controller (BMC) 120. The BMC 120 is configured to manage and monitor the hardware of the computing device. For example, the BMC 120 can include a microcontroller or processor, memory, sensors and monitoring interfaces, and communication interfaces. In some implementations, the motherboard can include multiple BMCs.

The computing device 100 can include one or more I2C devices. Each I2C device can include, for example, a sensor, e.g., a temperature sensor, a humidity sensor, motion sensor, or light sensor. The I2C device can also be a field replaceable unit (FRU), e.g., memory, or a fan.

In the example of FIG. 1, the BMC 120 includes 16 I2C channels. This specification describes an example of connecting six peripheral devices 130a-f using three of the I2C channels of the BMC, channel 122, 124, and 126. In other implementations, the BMC 120 can include any appropriate number of I2C channels and communicate with any appropriate number of I2C devices.

The BMC 120 is in communication with the MCU 110 using the I2C protocol. For example, in the I2C channel 122, the BMC 120 is the host, and the MCU 110 is the peripheral. In the I2C channel 124, the BMC 120 is the host, and the MCU 110 is the peripheral. In the I2C channel 126, the BMC 120 is the host, and the MCU 110 is the peripheral.

The MCU 110 is in communication with each of the I2C devices 130a-f. For example, in the I2C channel 112a, the MCU 110 is the host, and the I2C device 130a is the peripheral. In the I2C channel 112b, the MCU 110 is the host, and the I2C device 130b is the peripheral. In the I2C channel 112c, the MCU 110 is the host, and the I2C device 130c is the peripheral. In the I2C channel 112d, the MCU 110 is the host, and the I2C device 130d is the peripheral. In the I2C channel 112e, the MCU 110 is the host, and the I2C device 130e is the peripheral. In the I2C channel 112f, the MCU 110 is the host, and the I2C device 130f is the peripheral.

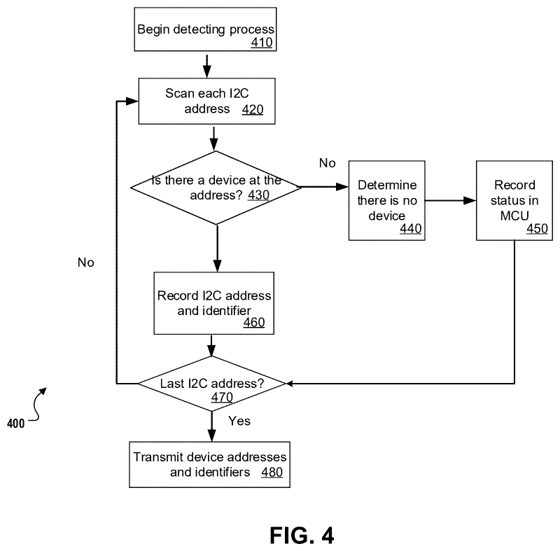

The MCU 110 is configured to detect status signals for the I2C devices and to determine identifiers for the I2C devices 130a-f. Determining the identifiers is described in further detail with reference to FIG. 4.

In some implementations, the MCU 110 can maintain the data representing the identifiers. For example, the MCU 110 can maintain the data representing the identifiers in a table. In some implementations, the MCU 110 can also maintain data representing the I2C addresses of the I2C devices 130a-f. An example table follows as Table 1. For example, the I2C device 130a, “PERIPHERAL1”, has an I2C address of 0x90 and an identifier of 0x01.

TABLE 1

| | I2C | I2C label |
|---|---|---|
| I2C device | address | number |
| PERIPHERAL1 | 0x90 | 0x01 |
| PERIPHERAL2 | 0x90 | 0x02 |
| PERIPHERAL3 | 0x92 | 0x03 |
| PERIPHERAL4 | 0x94 | 0x04 |
| PERIPHERAL5 | 0x96 | 0x05 |
| PERIPHERAL6 | 0x98 | 0x06 |

In some implementations, the MCU 110 is configured to transmit data representing the identifiers to the BMC 120. In some implementations, the BMC 120 can maintain the data representing the identifiers. In some implementations, the BMC 120 can transmit data representing the identifiers for display on a user device 140.

The MCU 110 is configured to assign the I2C devices 130a-f to channels corresponding to the BMC 120. For example, the MCU 110 can assign one or more of the I2C devices 130a-f to each of the channels 122, 124, and 126. In some implementations, the MCU 110 can maintain data representing the assignments. For example, the MCU 110 can maintain the data representing the assignments in a table such as Table 1. Example assignments are described below with reference to FIG. 2.

In some implementations, the MCU 110 can transmit data representing the identifiers for display on a user device 140. The user device 140 can include, for example, a desktop computer or laptop computer that includes a user interface for presenting data for display to a user, and/or receiving inputs from a user. The MCU 110 can thus allow for an understanding of the number of I2C devices with an active status that are in communication with the MCU 110.

The MCU 110 can receive a signal indicating an assignment update of at least one of the I2C devices 130a-f. The assignment update can specify one or more I2C devices for which to update the assignment. As a particular example, the assignment update can specify the one or more I2C devices using the identifier for each of the one or more I2C devices. The update assignment can also specify the new channel corresponding to the BMC 120 for which to assign the specified I2C devices. As a particular example, the assignment update can specify the new channel corresponding to the BMC 120 for which to assign a specified I2C device using the I2C address for the channel.

For example, the MCU 110 can receive the signal through a universal asynchronous receiver-transmitter (UART) protocol. The UART protocol is a communication protocol that allows for asynchronous data transmission between devices.

In some examples, the MCU 110 can receive the signal indicating the assignment update from the user device 140.

In some examples, the user device 140 can transmit the signal indicating the assignment update in response to receiving data identifying a problem with the assignment from the BMC 120. For example, the data identifying the problem can include a notification, e.g., a message or an email-message, that is transmitted from the BMC 120. The problem can include, for example, an I2C address conflict, or two or more I2C devices interfering with each other on the channel. For example, two I2C devices that both transmit a large amount of data over the channel may interfere with each other.

In some examples, the BMC 120 can transmit the data identifying the problem in response to performing one or more tests using the I2C devices 130a-f. For example, the BMC 120 can perform firmware testing to identify any problems in the I2C address. For example, the BMC 120 can perform firmware testing to identify I2C address conflicts. As another example, the BMC 120 can identify that two or more I2C devices interfere with each other based on the performance, e.g., latency, of the firmware testing.

The data identifying the problem can include the identifier for the one or more I2C devices for the problem. In some examples, the data identifying the problem can also include a suggestion for addressing the problem. For example, the data identifying the problem can include data representing another channel corresponding to the BMC to update the assignment of the I2C device to. As another example, the data identifying the problem can include data representing another channel corresponding to the BMC that is less loaded, to update the assignment of the I2C device to.

As a particular example, the data identifying the problem can include a status for each channel corresponding to the BMC. For example, the status may indicate that two or more I2C devices interfere with each other on a particular channel.

In response to receiving the signal, the MCU 110 can update the current assignment of the I2C devices 130a-f. An example assignment update is described below with reference to FIG. 2.

The computing device 100 can thus provide for the updated assignment of I2C devices using the MCU 110, without requiring any hardware-related changes. Furthermore, the MCU 110 can update the assignment of I2C devices at each of multiple iterations, allowing for dynamic tuning of the layout of the computing device.

FIG. 2 is a block diagram 200 of the MCU 110 of FIG. 1, according to an implementation of the present disclosure. In particular, FIG. 2 shows an example assignment of the I2C devices.

As an example, the I2C device 130a can be a temperature sensor. The I2C device 130b can be a voltage sensor, the I2C device 130c can be a current sensor, and the I2C device 130d can be a fan controller. In addition, the I2C device 130e can be a hard drive backplane FRU, and the I2C device 130f can be a PCIe Riser FRU.

In the example of FIG. 2, the I2C devices 130a-c are assigned to the channel 122 corresponding to the BMC 120. The I2C devices 130c-d are assigned to the channel 124 corresponding to the BMC 120. The I2C devices 130e-f are assigned to the channel 126 corresponding to the BMC 120.

As an example, the assignment shown in FIG. 2 can be an initial assignment of the I2C devices 130a-f. For example, the MCU 110 can perform the initial assignment of the I2C devices 130a-f. As an example, the MCU 110 can assign the I2C devices 130a-f so that each channel corresponding to the BMC 120 is assigned to an equal or a similar number of I2C devices. For example, the MCU 110 assigns three I2C devices to the channel 122. The MCU 110 assigns one I2C device to the channel 124. The MCU 110 assigns two I2C devices to the channel 126. As a particular example, the MCU 110 can divide the number of I2C devices by the number of channels corresponding to the BMC 120. The system can assign at least the divided number of I2C devices, up to the maximum number of devices that can be assigned to an I2C channel, to each of the channels until all the I2C devices have been assigned.

An example updated assignment is described below. For example, the MCU 110 can receive a signal, e.g., from the user device 140 of FIG. 1, that indicates an assignment update of the I2C device 130a to the channel 124.

In response to receiving the signal, the MCU 110 can update the assignment of the I2C device 130a to the channel 124. For example, the MCU 110 can update the corresponding table maintained by the MCU 110 to reflect that the corresponding channel for the I2C device 130a is the channel 124, rather than the channel 122.

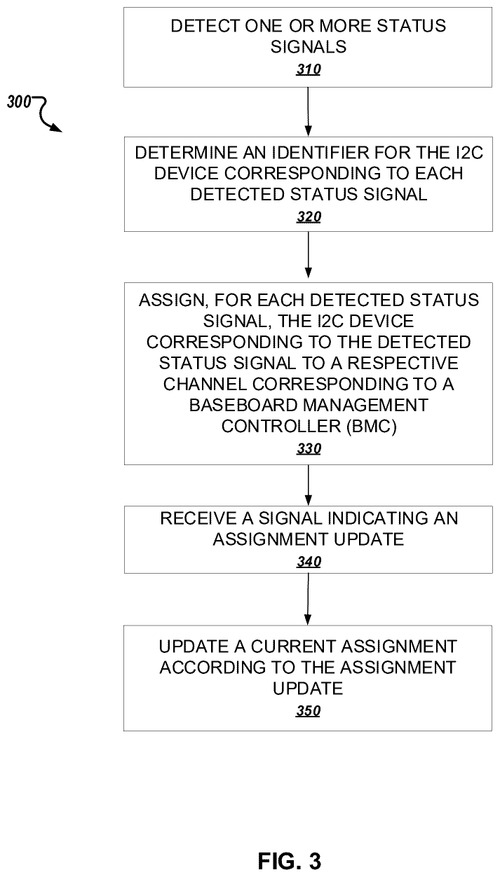

FIG. 3 is a flowchart illustrating an example of a computer-implemented method 300 for updating the assignment of I2C devices using an MCU, according to an implementation of the present disclosure. For clarity of presentation, the description that follows generally describes method 300 in the context of the other figures in this description. However, it will be understood that method 300 can be performed, for example, by any system, environment, software, and hardware, or a combination of systems, environments, software, and hardware, as appropriate. In some implementations, various steps of method 300 can be run in parallel, in combination, in loops, or in any order. In some implementations, the computing device 100 can perform one or more, or all of the processes described in the method 300.

At 310, the system detects, by a microcontroller unit (MCU) and as detected status signals, one or more status signals. Each status signal corresponds to an inter-integrated circuit (I2C) device of one or more I2C devices.

At 320, the system determines, by the MCU and as identifiers, an identifier for the I2C device corresponding to each detected status signal of the detected status signals. Determining the identifiers are described below in further detail with reference to FIG. 4.

In some implementations, the system maintains, by the MCU, the data representing the identifiers. For example, the MCU can maintain a table of data representing the identifiers as described above with reference to FIG. 1. In some implementations, the system can transmit, by the MCU, the data representing the identifiers for display on a user device, e.g., using a UART protocol.

In some implementations, the system also maintains, by the MCU, data representing an I2C address for each of the one or more I2C devices. For example, the MCU can maintain a table of data representing the I2C addresses as described above with reference to FIG. 1. In some implementations, the system can transmit, by the MCU, the data representing the I2C addresses for display on a user device, e.g., using a UART protocol.

In some implementations, the system transmits, by the MCU, data representing the identifiers to a BMC.

At 330, the system assigns, by the MCU, for each detected status signal, the I2C device corresponding to the detected status signal of the detected status signals to a respective channel corresponding to the BMC.

At 340, the system receives, by the MCU, a signal indicating an assignment update. The signal indicates an assignment update of at least one of the I2C devices corresponding to the detected status signals to a respective different channel. For example, the signal can indicate the assignment update using the identifier for each of the at least one I2C devices.

In some implementations, the MCU receives the signal through a UART protocol.

In some implementations, the MCU receives the signal from a user device. For example, the user device can transmit the signal in response to receiving data identifying a problem with the assignment from the BMC. In some examples, the BMC can transmit the data identifying the problem with the assignment in response to performing one or more tests, e.g., firmware tests for each of the channels, using the I2C devices.

At 350, in response to receiving the signal, the system updates, as an updated assignment, a current assignment according to the assignment update.

In some examples, after updating the current assignment to the updated assignment, the MCU updates the updated assignment at each of multiple iterations. For example, the system can receive, by the MCU, a second signal indicating a second assignment update of at least one of the I2C devices corresponding to the detected status signals to a respective different channel. In response to receiving the second signal, the system can update the updated assignment according to the second assignment update. The system can continue to receive further signals and update the assignment of the I2C devices according to the further signals by performing 340 and 350 at each iteration.

FIG. 4 is a flowchart illustrating an example of a computer-implemented method 400 for determining identifiers for I2C devices, according to an implementation of the present disclosure. For clarity of presentation, the description that follows generally describes method 400 in the context of the other figures in this description. However, it will be understood that method 400 can be performed, for example, by any system, environment, software, and hardware, or a combination of systems, environments, software, and hardware, as appropriate. In some implementations, various steps of method 400 can be run in parallel, in combination, in loops, or in any order. In some implementations, the computing device 100 can perform one or more, or all of the processes described in the method 400.

At 410, the detection process begins. As an example, the detection process can begin when the computing device is powered on.

At 420, each I2C address is scanned. For example, the MCU scans each I2C address over the communication channels for which the MCU is the controller device. For example, the MCU can scan the I2C addresses in order of increasing I2C address, e.g., for a two byte address, from 0x00 to 0xFF.

As a particular example, the MCU can send a start condition to begin the I2C communication. The MCU can send an I2C address for each possible I2C address. The MCU can also send a read or write bit with the I2C address. If there is a device at the I2C address, the device can respond with an acknowledgment.

At 430, for each I2C address, a determination is made as to whether there is a device at the address. For example, the MCU can determine that there is a device at the address if an acknowledgment is received by the MCU for the address.

At 440, if it is determined that there is no device at the address, the method proceeds to 450. At 450, the status can be recorded in the MCU. For example, the MCU can maintain data representing that there is no device at the I2C address or there is no active device at the I2C address.

If it is determined that there is a device at the address, the method proceeds to 460. At 460, the I2C address and the identifier can be recorded in the MCU. For example, the MCU can maintain data representing the I2C address. The MCU can assign the identifier for the I2C device. The identifier is a unique identifier for the I2C devices. As an example, the MCU can assign increasing non-zero integers as the identifiers.

At 470, a determination is made as to whether the I2C address being scanned is the last I2C address.

For example, if it is determined that the I2C address is the last possible I2C address, the method proceeds to 480. At 480, the device addresses and identifiers are transmitted. For example, the MCU can transmit data representing the device addresses and identifiers to the BMC. As another example, the MCU can transmit data representing the device addresses and identifiers to a user device. In some examples, the MCU can transmit the data representing the device addresses and the identifiers over the UART protocol.

If it is determined that the I2C address is not the last possible I2C address, the method proceeds to 420. For example, the MCU can return to 420 to scan the next I2C address.

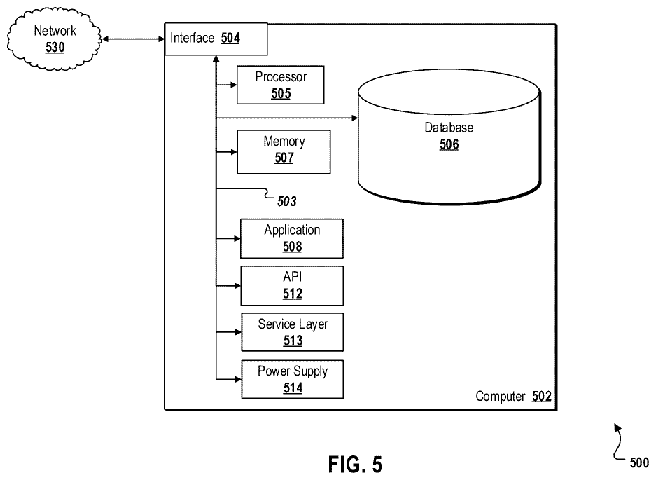

FIG. 5 is a block diagram illustrating an example of a computer-implemented System 500 used to provide computational functionalities associated with described algorithms, methods, functions, processes, flows, and procedures, according to an implementation of the present disclosure. In the illustrated implementation, computer-implemented system 500 includes a Computer 502 and a Network 530.

The illustrated Computer 502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 502 can include an input device, such as a keypad, keyboard, or touch screen, or a combination of input devices that can accept user information, and an output device that conveys information associated with the operation of the Computer 502, including digital data, visual, audio, another type of information, or a combination of types of information, on a graphical-type user interface (UI) (or GUI) or other UI.

The Computer 502 can serve in a role in a distributed computing system as, for example, a client, network component, a server, or a database or another persistency, or a combination of roles for performing the subject matter described in the present disclosure. The illustrated Computer 502 is communicably coupled with a Network 530. In some implementations, one or more components of the Computer 502 can be configured to operate within an environment, or a combination of environments, including cloud-computing, local, or global.

At a high level, the Computer 502 is an electronic computing device operable to receive, transmit, process, store, or manage data and information associated with the described subject matter. According to some implementations, the Computer 502 can also include or be communicably coupled with a server, such as an application server, e-mail server, web server, caching server, or streaming data server, or a combination of servers.

The Computer 502 can receive requests over Network 530 (for example, from a client software application executing on another Computer 502) and respond to the received requests by processing the received requests using a software application or a combination of software applications. In addition, requests can also be sent to the Computer 502 from internal users (for example, from a command console or by another internal access method), external or third-parties, or other entities, individuals, systems, or computers.

Each of the components of the Computer 502 can communicate using a System Bus 503. In some implementations, any or all of the components of the Computer 502, including hardware, software, or a combination of hardware and software, can interface over the System Bus 503 using an application programming interface (API) 512, a Service Layer 513, or a combination of the API 512 and Service Layer 513. The API 512 can include specifications for routines, data structures, and object classes. The API 512 can be either computer-language independent or dependent and refer to a complete interface, a single function, or even a set of APIs. The Service Layer 513 provides software services to the Computer 502 or other components (whether illustrated or not) that are communicably coupled to the Computer 502. The functionality of the Computer 502 can be accessible for all service consumers using the Service Layer 513. Software services, such as those provided by the Service Layer 513, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 502, alternative implementations can illustrate the API 512 or the Service Layer 513 as stand-alone components in relation to other components of the Computer 502 or other components (whether illustrated or not) that are communicably coupled to the Computer 502. Moreover, any or all parts of the API 512 or the Service Layer 513 can be implemented as a child or a sub-module of another software module, enterprise application, or hardware module without departing from the scope of the present disclosure.

The Computer 502 includes an Interface 504. Although illustrated as a single Interface 504, two or more Interfaces 504 can be used according to particular needs, desires, or particular implementations of the Computer 502. The Interface 504 is used by the Computer 502 for communicating with another computing system (whether illustrated or not) that is communicatively linked to the Network 530 in a distributed environment. Generally, the Interface 504 is operable to communicate with the Network 530 and includes logic encoded in software, hardware, or a combination of software and hardware. More specifically, the Interface 504 can include software supporting one or more communication protocols associated with communications such that the Network 530 or hardware of Interface 504 is operable to communicate physical signals within and outside of the illustrated Computer 502.

The Computer 502 includes a Processor 505. Although illustrated as a single Processor 505, two or more Processors 505 can be used according to particular needs, desires, or particular implementations of the Computer 502. Generally, the Processor 505 executes instructions and manipulates data to perform the operations of the Computer 502 and any algorithms, methods, functions, processes, flows, and procedures as described in the present disclosure.

The Computer 502 also includes a Database 506 that can hold data for the Computer 502, another component communicatively linked to the Network 530 (whether illustrated or not), or a combination of the Computer 502 and another component. For example, Database 506 can be an in-memory or conventional database storing data consistent with the present disclosure. In some implementations, Database 506 can be a combination of two or more different database types (for example, a hybrid in-memory and conventional database) according to particular needs, desires, or particular implementations of the Computer 502 and the described functionality. Although illustrated as a single Database 506, two or more databases of similar or differing types can be used according to particular needs, desires, or particular implementations of the Computer 502 and the described functionality. While Database 506 is illustrated as an integral component of the Computer 502, in alternative implementations, Database 506 can be external to the Computer 502. The Database 506 can hold and operate on at least any data type mentioned or any data type consistent with this disclosure.

The Computer 502 also includes a Memory 507 that can hold data for the Computer 502, another component or components communicatively linked to the Network 530 (whether illustrated or not), or a combination of the Computer 502 and another component. Memory 507 can store any data consistent with the present disclosure. In some implementations, Memory 507 can be a combination of two or more different types of memory (for example, a combination of semiconductor and magnetic storage) according to particular needs, desires, or particular implementations of the Computer 502 and the described functionality. Although illustrated as a single Memory 507, two or more Memories 507 or similar or differing types can be used according to particular needs, desires, or particular implementations of the Computer 502 and the described functionality. While Memory 507 is illustrated as an integral component of the Computer 502, in alternative implementations, Memory 507 can be external to the Computer 502.

The Application 508 is an algorithmic software engine providing functionality according to particular needs, desires, or particular implementations of the Computer 502, particularly with respect to functionality described in the present disclosure. For example, Application 508 can serve as one or more components, modules, or applications. Further, although illustrated as a single Application 508, the Application 508 can be implemented as multiple Applications 508 on the Computer 502. In addition, although illustrated as integral to the Computer 502, in alternative implementations, the Application 508 can be external to the Computer 502.

The Computer 502 can also include a Power Supply 514. The Power Supply 514 can include a rechargeable or non-rechargeable battery that can be configured to be either user- or non-user-replaceable. In some implementations, the Power Supply 514 can include power-conversion or management circuits (including recharging, standby, or another power management functionality). In some implementations, the Power Supply 514 can include a power plug to allow the Computer 502 to be plugged into a wall socket or another power source to, for example, power the Computer 502 or recharge a rechargeable battery.

There can be any number of Computers 502 associated with, or external to, a computer system containing Computer 502, each Computer 502 communicating over Network 530. Further, the term “client,” “user,” or other appropriate terminology can be used interchangeably, as appropriate, without departing from the scope of the present disclosure. Moreover, the present disclosure contemplates that many users can use one Computer 502, or that one user can use multiple computers 502.

Described implementations of the subject matter can include one or more features, alone or in combination.

For example, in a first implementation, a computer-implemented method comprises: detecting, by a microcontroller unit (MCU) and as detected status signals, one or more status signals, each corresponding to an inter-integrated circuit (I2C) device of one or more I2C devices; determining, by the MCU and as identifiers, an identifier for the I2C device corresponding to each detected status signal of the detected status signals; assigning, by the MCU, for each detected status signal, the I2C device corresponding to each detected status signal of the detected status signals to a respective channel corresponding to a baseboard management controller (BMC); receiving, by the MCU, a signal indicating an assignment update of at least one of the I2C devices corresponding to the detected status signals to a respective different channel; and in response to receiving the signal, updating, as an updated assignment, a current assignment according to the assignment update.

The foregoing and other described implementations can each, optionally, include one or more of the following features:

A first feature, combinable with any of the following features, comprising maintaining, by the MCU, data representing the identifiers.

A second feature, combinable with any of the following features, comprising transmitting, by the MCU, the data representing the identifiers for display on a user device.

A third feature, combinable with any of the following features, wherein transmitting, by the MCU, the data representing the identifiers for display on a user device, comprises transmitting the data representing the identifiers through a universal asynchronous receiver-transmitter (UART) protocol.

A fourth feature, combinable with any of the following features, comprising maintaining, by the MCU, data representing an I2C address for each of the one or more I2C devices.

A fifth feature, combinable with any of the following features, wherein the one or more I2C devices comprise any one or more of: a sensor, or a field replaceable unit.

A sixth feature, combinable with any of the following features, wherein the signal indicating an assignment update of at least one of the I2C devices, comprises, for the at least one I2C devices, an identifier for the at least one I2C devices.

A seventh feature, combinable with any of the following features, wherein receiving, by the MCU, a signal indicating an assignment update of at least one of the I2C devices corresponding to the detected status signals to a respective different channel comprises receiving the signal through a universal asynchronous receiver-transmitter (UART) protocol.

An eighth feature, combinable with any of the following features, wherein receiving, by the MCU, a signal indicating an assignment update of at least one of the I2C devices corresponding to the detected status signals to a respective different channel, comprises receiving the signal from a user device.

A ninth feature, combinable with any of the following features, wherein, in response to receiving data identifying a problem with the assignment from the BMC, the user device transmits the signal.

A tenth feature, combinable with any of the following features, wherein the BMC has transmitted the data identifying the problem with the assignment in response to performing one or more tests using the I2C devices.

An eleventh feature, combinable with any of the following features, comprising: receiving, by the MCU, a second signal indicating a second assignment update of at least one of the I2C devices corresponding to the detected status signals to a respective different channel; and in response to receiving the second signal, updating the updated assignment according to the second assignment update.

In a second implementation, a computer-implemented system comprises: a baseboard management controller (BMC); one or more inter-integrated circuit (I2C) devices; and a microcontroller unit (MCU) configured to perform operations comprising: detecting, as detected status signals, one or more status signals, each corresponding to an I2C device of the one or more I2C devices; determining, as identifiers, an identifier for the I2C device corresponding to each detected status signal of the detected status signals; assigning, for each detected status signal, the I2C device corresponding to each detected status signal of the detected status signals to a respective channel corresponding to the BMC; receiving a signal indicating an assignment update of at least one of the I2C devices corresponding to the detected status signals to a respective different channel; and in response to receiving the signal, updating, as an updated assignment, a current assignment according to the assignment update.

The foregoing and other described implementations can each, optionally, include one or more of the following features:

A first feature, combinable with any of the following features, wherein the operations comprise maintaining, by the MCU, data representing the identifiers.

A second feature, combinable with any of the following features, wherein the system comprises a user device, and wherein the operations comprise transmitting, by the MCU, the data representing the identifiers for display on the user device.

A third feature, combinable with any of the following features, wherein transmitting the data representing the identifiers for display on a user device comprises transmitting the data representing the identifiers through a universal asynchronous receiver-transmitter (UART) protocol.

A fourth feature, combinable with any of the following features, wherein the operations comprise maintaining, by the MCU, data representing an I2C address for each of the one or more I2C devices.

A fifth feature, combinable with any of the following features, wherein the one or more I2C devices comprise any one or more of: a sensor, or a field replaceable unit.

A sixth feature, combinable with any of the following features, wherein the signal indicating an assignment update of at least one of the I2C devices, comprises, for the at least one I2C devices, an identifier for the at least one I2C devices.

A seventh feature, combinable with any of the following features, wherein receiving a signal indicating an assignment update of at least one of the one or more I2C devices corresponding to the detected status signals to a respective different channel comprises receiving the signal through a universal asynchronous receiver-transmitter (UART) protocol.

An eighth feature, combinable with any of the following features, wherein the system comprises a user device, and wherein receiving a signal indicating an assignment update of at least one of the I2C devices corresponding to the detected status signals to a respective different channel, comprises receiving the signal from the user device.

A ninth feature, combinable with any of the following features, wherein, in response to receiving data identifying a problem with the assignment from the BMC, the user device transmits the signal.

A tenth feature, combinable with any of the following features, wherein the BMC has transmitted the data identifying the problem with the assignment in response to performing one or more tests using the I2C devices.

An eleventh feature, combinable with any of the following features, wherein the operations comprise receiving, by the MCU, a second signal indicating a second assignment update of at least one of the I2C devices corresponding to the detected status signals to a respective different channel; and in response to receiving the second signal, updating the updated assignment according to the second assignment update.

In a third implementation, a non-transitory, computer-readable medium storing one or more instructions executable by a computer system to perform one or more operations, comprising: detecting, by a microcontroller unit (MCU) and as detected status signals, one or more status signals, each corresponding to an inter-integrated circuit (I2C) device of one or more I2C devices; determining, by the MCU and as identifiers, an identifier for the I2C device corresponding to each detected status signal of the detected status signals; assigning, by the MCU, for each detected status signal, the I2C device corresponding to each detected status signal of the detected status signals to a respective channel corresponding to a baseboard management controller (BMC); receiving, by the MCU, a signal indicating an assignment update of at least one of the I2C devices corresponding to the detected status signals to a respective different channel; and in response to receiving the signal, updating, as an updated assignment, a current assignment according to the assignment update.

The foregoing and other described implementations can each, optionally, include one or more of the following features:

A first feature, combinable with any of the following features, comprising maintaining, by the MCU, data representing the identifiers.

A second feature, combinable with any of the following features, comprising transmitting, by the MCU, the data representing the identifiers for display on a user device.

A third feature, combinable with any of the following features, wherein transmitting, by the MCU, the data representing the identifiers for display on a user device, comprises transmitting the data representing the identifiers through a universal asynchronous receiver-transmitter (UART) protocol.

A fourth feature, combinable with any of the following features, comprising maintaining, by the MCU, data representing an I2C address for each of the one or more I2C devices.

A fifth feature, combinable with any of the following features, wherein the one or more I2C devices comprise any one or more of: a sensor, or a field replaceable unit.

A sixth feature, combinable with any of the following features, wherein the signal indicating the assignment update of at least one of the I2C devices comprises, for the at least one I2C devices, the identifier for the I2C device.

A seventh feature, combinable with any of the following features, wherein receiving, by the MCU, a signal indicating an assignment update of at least one of the I2C devices corresponding to the detected status signals to a respective different channel comprises receiving the signal through a universal asynchronous receiver-transmitter (UART) protocol.

An eighth feature, combinable with any of the following features, wherein receiving, by the MCU, a signal indicating an assignment update of at least one of the I2C devices corresponding to the detected status signals to a respective different channel, comprises receiving the signal from a user device.

A ninth feature, combinable with any of the following features, wherein, in response to receiving data identifying a problem with the assignment from the BMC, the user device transmits the signal.

A tenth feature, combinable with any of the following features, wherein the BMC has transmitted the data identifying the problem with the assignment in response to performing one or more tests using the I2C devices.

An eleventh feature, combinable with any of the following features, comprising: receiving, by the MCU, a second signal indicating a second assignment update of at least one of the I2C devices corresponding to the detected status signals to a respective different channel; and in response to receiving the second signal, updating the updated assignment according to the second assignment update.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
detecting, by a microcontroller unit (MCU) and as detected status signals, one or more status signals, each corresponding to an inter-integrated circuit (I2C) device of one or more I2C devices;
determining, by the MCU and as identifiers, an identifier for the I2C device corresponding to each detected status signal of the detected status signals;
assigning, by the MCU, for each detected status signal, the I2C device corresponding to each detected status signal of the detected status signals to a respective channel corresponding to a baseboard management controller (BMC);
receiving, by the MCU, a signal indicating an assignment update of at least one of the I2C devices corresponding to the detected status signals to a respective different channel; and
in response to receiving the signal, updating, as an updated assignment, a current assignment according to the assignment update.

2. The computer-implemented method of claim 1, comprising maintaining, by the MCU, data representing the identifiers.

3. The computer-implemented method of claim 2, comprising transmitting, by the MCU, the data representing the identifiers for display on a user device.

4. The computer-implemented method of claim 2, wherein transmitting, by the MCU, the data representing the identifiers for display on a user device, comprises transmitting the data representing the identifiers through a universal asynchronous receiver-transmitter (UART) protocol.

5. The computer-implemented method of claim 1, comprising maintaining, by the MCU, data representing an I2C address for each of the one or more I2C devices.

6. The computer-implemented method of claim 1, wherein the one or more I2C devices comprise any one or more of: a sensor, or a field replaceable unit.

7. The computer-implemented method of claim 1, wherein the signal indicating an assignment update of at least one of the I2C devices, comprises, for the at least one I2C devices, an identifier for the at least one I2C devices.

8. The computer-implemented method of claim 1, wherein receiving, by the MCU, a signal indicating an assignment update of at least one of the I2C devices corresponding to the detected status signals to a respective different channel comprises receiving the signal through a universal asynchronous receiver-transmitter (UART) protocol.

9. The computer-implemented method of claim 1, wherein receiving, by the MCU, a signal indicating an assignment update of at least one of the I2C devices corresponding to the detected status signals to a respective different channel, comprises receiving the signal from a user device.

10. The computer-implemented method of claim 9, wherein, in response to receiving data identifying a problem with the assignment from the BMC, the user device transmits the signal.

11. The computer-implemented method of claim 10, wherein the BMC has transmitted the data identifying the problem with the assignment in response to performing one or more tests using the I2C devices.

12. The computer-implemented method of claim 1, comprising:
receiving, by the MCU, a second signal indicating a second assignment update of at least one of the I2C devices corresponding to the detected status signals to a respective different channel; and
in response to receiving the second signal, updating the updated assignment according to the second assignment update.

13. A computer-implemented system comprising:
a baseboard management controller (BMC);
one or more inter-integrated circuit (I2C) devices; and
a microcontroller unit (MCU) configured to perform operations comprising:
detecting, as detected status signals, one or more status signals, each corresponding to an I2C device of the one or more I2C devices;
determining, as identifiers, an identifier for the I2C device corresponding to each detected status signal of the detected status signals;
assigning, for each detected status signal, the I2C device corresponding to each detected status signal of the detected status signals to a respective channel corresponding to the BMC;
receiving a signal indicating an assignment update of at least one of the I2C devices corresponding to the detected status signals to a respective different channel; and
in response to receiving the signal, updating, as an updated assignment, a current assignment according to the assignment update.

14. The computer-implemented system of claim 13, wherein the operations comprise maintaining, by the MCU, data representing the identifiers.

15. The computer-implemented system of claim 14, comprising a user device, and wherein the operations comprise transmitting, by the MCU, the data representing the identifiers for display on the user device.

16. The computer-implemented system of claim 15, wherein transmitting, by the MCU, the data representing the identifiers for display on the user device comprises transmitting the data representing the identifiers through a universal asynchronous receiver-transmitter (UART) protocol.

17. The computer-implemented system of claim 13, wherein the one or more I2C devices comprise any one or more of: a sensor, or a field replaceable unit.

18. The computer-implemented system of claim 13, wherein receiving a signal indicating an assignment update of at least one of the one or more I2C devices corresponding to the detected status signals to a respective different channel comprises receiving the signal through a universal asynchronous receiver-transmitter (UART) protocol.

19. The computer-implemented system of claim 13, comprising a user device, and wherein receiving a signal indicating an assignment update of at least one of the one or more I2C devices corresponding to the detected status signals to a respective different channel comprises receiving the signal from the user device.

20. A non-transitory, computer-readable medium storing one or more instructions executable by a computer system to perform one or more operations, comprising:
detecting, by a microcontroller unit (MCU) and as detected status signals, one or more status signals, each corresponding to an inter-integrated circuit (I2C) device of one or more I2C devices;
determining, by the MCU and as identifiers, an identifier for the I2C device corresponding to each detected status signal of the detected status signals;
assigning, by the MCU, for each detected status signal, the I2C device corresponding to each detected status signal of the detected status signals to a respective channel corresponding to a baseboard management controller (BMC);
receiving, by the MCU, a signal indicating an assignment update of at least one of the I2C devices corresponding to the detected status signals to a respective different channel; and
in response to receiving the signal, updating, as an updated assignment, a current assignment according to the assignment update.
